(19) United States
(12) Patent Application Publication
(10) Pub. No.: US 2014/0220813 A1
(43) Pub. Date: Aug. 7, 2014

(54) MULTI-OUTLET ELECTRICAL UNIT

(71) Applicant: Benz Nguyen, Atlanta, GA (US)

(72) Inventor: Benz Nguyen, Atlanta, GA (US)

(21) Appl. No.: 13/762,009

(22) Filed: Feb. 7, 2013

(51) Int. Cl. H01R 13/58; H01R 43/26

(52) U.S. Cl. CPC H01R 13/58; H01R 43/26
USPC 439/445; 29/825

(57) ABSTRACT

Various implementations of this disclosure provide apparatuses and methods for powering one or more devices and storing or arranging a part of the power cords. In some implementations, a multi-outlet electrical unit includes a first plate including a plurality of electrical outlets, a second plate including at least one plug, and a recess surface between the first plate and the second plate configured to wrap at least one power cord around. One or more devices are powered using the multi-outlet electrical unit by plugging a plug attached to a power cord into one of the electrical outlets; and wrapping a part of the power cord around the recess surface.

### TECHNICAL FIELD

This disclosure relates to implementations of a multi-outlet electrical unit.

### BACKGROUND

Existing multi-outlet electrical units, such as power strips, do not include means to store or arrange any unused part of power cords connected to the outlets.

### BRIEF DESCRIPTION OF THE DRAWINGS

FIGS. 1-2 illustrate an example multi-outlet electrical unit that can store any unused part of power cords connected to the outlets.

FIG. 3 illustrates the multi-outlet electrical unit of FIGS. 1-2 without a power cord.

FIG. 4 illustrates a side view of the multi-outlet electrical unit of FIGS. 1-2.

### DETAILED DESCRIPTION

Various implementations of this disclosure provide a multi-outlet electrical unit that can store an unused part of power cords connected to the outlets. In some implementations, the multi-outlet electrical unit can be wall mounted. In some implementations, the multi-outlet electrical unit can include outlets that can be rotated. In some implementations, the multi-outlet electrical unit can include one or more USB outlets.

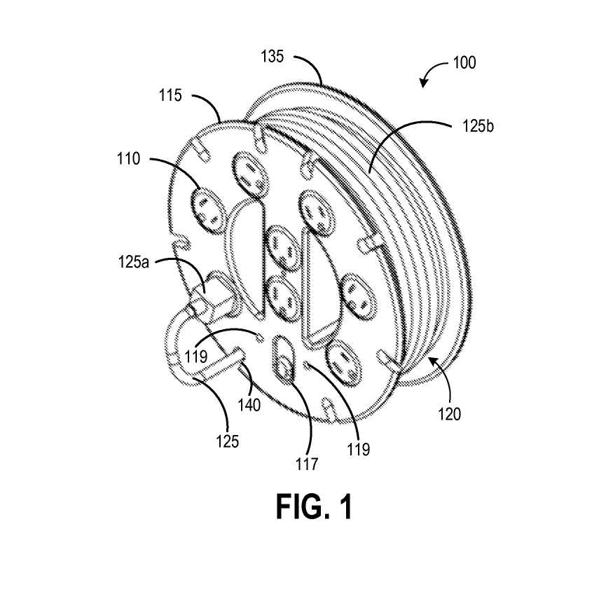

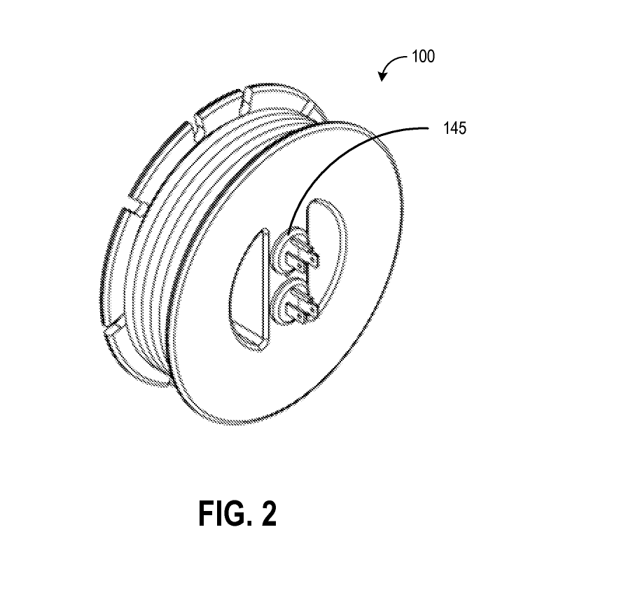

FIGS. 1-2 illustrate an example multi-outlet electrical unit 100 that can store an unused part of power cords connected to the outlets. The multi-outlet electrical unit 100 can include multiple electrical outlets 110 on a first plate 115. In some implementations, one or more of the electrical outlets can have different characteristics (e.g., voltage and current rating, size, shape, type). In some implementations, the electrical outlets can be any outlet that meets the National Electrical Manufacturers Association (NEMA) standard. In other implementations, the electrical outlets can be any electrical outlet. In some implementations, one or more of the electrical outlets can rotate. In some implementations, one or more of the electrical outlets can be a USB port.

In some implementations, as shown in FIG. 1, the first plate 115 can be circular. In other implementations, the first plate 115 can be any shape. In some implementation, the first plate 115 can include an on/off switch 117 and indicator lights 119. In some implementations, one indicator light may be green and the other indicator light may be red. In some implementations, an illuminated green light may indicate that the electrical unit is powered on. In some implementations, an illuminated red light may indicate an overload condition.

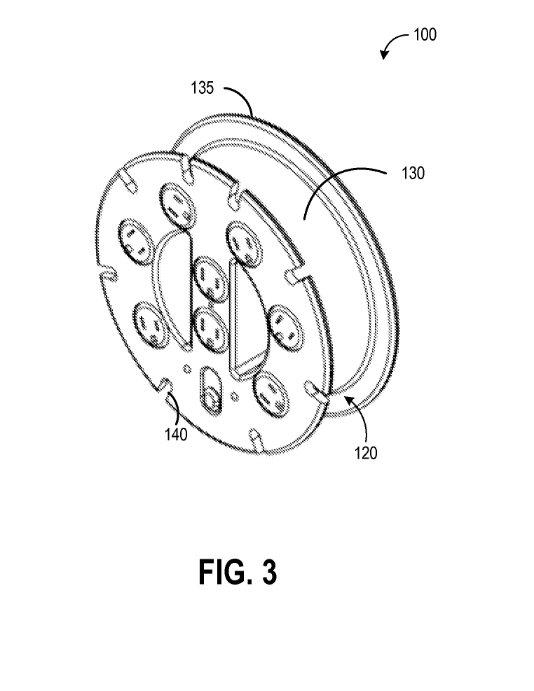

The multi-outlet electrical unit 100 also can include a storage area 120 for storing an unused part of power cords connected to the outlets. For example, the unused part of the power cord 125 can be stored in storage area 120. For example, a part of the power cord between the plug 125a and the other end of the power cord that connects to a device (not shown) can be stored in the storage area 120. FIG. 3 illustrates the multi-outlet electrical unit 100 of FIGS. 1-2 without the power cord 125. As shown in FIG. 3, in some implementations, the storage area 120 can include a recessed surface 130 between the first plate 115 and a second plate 135 for wrapping an unused part 125b of the power cord 125 around. In some implementations, the width of the recess area 130 (e.g., the distance between the first plate 115 and the second plate 135) is at least 2 inches. In other implementations, the width of the recess area 130 can be smaller or larger. As shown in FIG. 2, the second plate 135 can include one or more plugs 145 to connect the multi-outlet electrical unit 100 to a power source (e.g., a wall outlet).

As shown in FIG. 1, a part of the power cord 125 can be inserted in a groove 140 in the first plate 115 to help arrange the power cord 125. In some implementations, the first plate 115 can include a plurality of grooves 140 around its perimeter to further help arrange the power cords connected to the outlets. In some implementations, each outlet of a plurality of outlets can have a corresponding groove in the vicinity of the outlet. For example, in some implementations, each outlet of a plurality of outlets can have a corresponding groove within about 1 inch from the center of the outlet. In other implementations, a groove may be closer to or farther from the outlet. In some implementations, the width of the groove at the perimeter of the first plate 115 is smaller than the width of the groove at the opposite end. In this way, the power cord may not easily slide out of the groove.

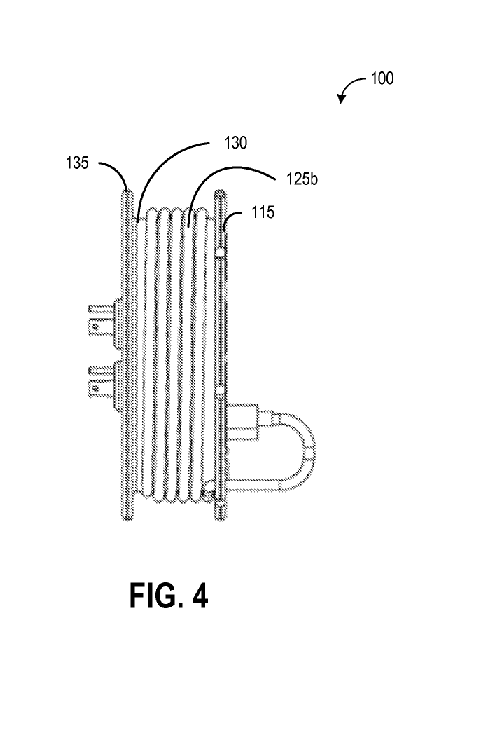

FIG. 4 illustrates a side view of the multi-outlet electrical unit 100 FIGS. 1-2. As shown in FIG. 4, the unused part 125b of the power cord 125 can be inserted in a groove and wrapped around the recessed surface 130 between the first plate 115 and the second plate 135.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An apparatus comprising:
a first plate including a plurality of electrical outlets;
a second plate including at least one plug; and
a recess surface between the first plate and the second plate configured to wrap at least one power cord around.

2. An apparatus according claim 1 wherein the first plate further includes at least one USB port.

3. An apparatus according claim 1 wherein the plurality of electrical outlets are configured to rotate.

4. An apparatus according claim 1 wherein the first plate is circular.

5. An apparatus according claim 1 wherein the first plate includes a plurality of grooves around its perimeter.

6. An apparatus according claim 5 wherein for each groove, the width of the groove at the perimeter of the first plate is smaller than the width of the groove at the opposite end of the groove.

7. A method of powering one or more devices using the apparatus of claim 1 comprising:
plugging a plug attached to a power cord into one of the electrical outlets; and
wrapping a part of the power cord around the recess surface.

8. The method of claim 7 wherein the apparatus of claim 1 includes the apparatus of claim 5, the method further comprising inserting a part of the power cord into one of the grooves.

9. The method of claim 7 further comprising inserting the at least one plug of the second plate into a wall outlet.
